(19) United States
(12) Patent Application Publication
(10) Pub. No.: US 2013/0152179 A1
(43) Pub. Date: Jun. 13, 2013

(54) SYSTEM AND METHOD FOR USER AUTHENTICATION USING ONE-TIME IDENTIFICATION

(71) Applicant: Electronics and Telecommunications Research, Daejeon (KR)

(72) Inventors: Hyung Kyu LEE, Daejeon (KR); Song-woo Sok, Daejeon (KR); Ga Gue Kim, Daejeon (KR)

(73) Assignee: Electronics and Telecommunications Research Institute, Daejeon (KR)

(21) Appl. No.: 13/676,732

(22) Filed: Nov. 14, 2012

(30) Foreign Application Priority Data
Dec. 9, 2011 (KR) 10-2011-0132071

(51) Int. Cl. G06F 21/00

(52) U.S. Cl. 726/6

(57) ABSTRACT

A system for user authentication using OTIDs (one-time identifications), includes a client terminal configured to generate n number of OTIDs which is used in the user authentication, and sequentially select one of the generated n number of OTIDs to use the selected OTID as a user identification in each authentification session. Further, the system includes an authentication server configured to receive the generated n number of OTIDs from the client terminal to store same, when the one OTID selected from the n number of OTID and a secret key are transmitted, inquire the OTID in a DB (database), and determine whether a secret key which is associated with the inquired OTID and stored in the DB and the received secret key is matched to performing the user authentication.

### CROSS-REFERENCE TO RELATED APPLICATIONS

The present invention claims priority of Korean Patent Application No. 10-2011-0132071, filed on Dec. 9, 2011 which is incorporated herein by reference.

### FIELD OF THE INVENTION

The present invention relates to a protection of personal information for a user in an internet; more particularly, to a system and method for user authentication using a one-time identification, which are capable of preventing hacking.

### BACKGROUND OF THE INVENTION

In general, in order for authentification of a user, an authentication certificate, identification (ID), a password, a smartcard, biological information and the like are used.

Among the user authentication methods, the ID/password authentication method is mainly used in Internet services. The certificate authentication method is used in some internet services in which security is of great importance. Further, in order to protect personal information of the user, an i-pin (Internet Personal Identification number) has been used to substitute a resident registration number.

However, in the ID/password authentication method used in the internet for the authentification of the user, a user ID is continuously used and always exposed to the public. Accordingly, the ID/password authentication method is weak in security when hacking occurs.

Moreover, a private user generally uses the same ID or similar IDs for the sake of convenience in order to obtain a plurality of web services. Therefore, the exposed ID may be useful information to attackers such as hackers and the like.

Furthermore, as social network services have been recently provided, such ID information may be a clue that leads private information of the user to be extracted and combined from several sites using a socio-technical method. As such, the importance of ID security becomes more significant.

In other words, big sites such as web and portal sites or others, in which a great amount of private information of the user is accumulated, become a target of the hackers. As a result, a large quantity of the private information often leaks out. Consequently, the necessity for changing the private information and social expenses are much highly increased.

Further, the i-pin has been used for preventing the resident registration number which is most important among the private information from being exposed the public. However, the issued i-pin is continuously used until it is reissued so that the i-pin may not provide an efficient method for protecting the private information from malicious attacks.

### SUMMARY OF THE INVENTION

In view of the above, the present invention provides a system and method for user authentification, using a one-time identification, which are capable of preventing hacking by updating a user identification either at every log-in or by specific periods and deleting the previous user identification, to enable identity and similarity between identifications being used in web services log-in not to exist, thereby preventing malicious and illegal use of the user identification using leaked identification and reducing use of the leaked information even though private information such as a log-in ID which is stored in a site is leaked.

In accordance with a first aspect of the present invention, there is provide a system for user authentication using OTIDs (one-time identifications), the system including: a client terminal configured to generate n number of OTIDs which is used in the user authentication, and sequentially select one of the generated n number of OTIDs to use the selected OTID as a user identification in each authentification session; and an authentication server configured to receive the generated n number of OTIDs from the client terminal to store same, when the one OTID selected from the n number of OTID and a secret key are transmitted, inquire the OTID in a DB (data base), and determine whether a secret key which is associated with the inquired OTID and stored in the DB and the received secret key is matched to performing the user authentication.

In accordance with a second aspect of the present invention, there is provide a method for user authentication using a one-time identification, including: a client terminal generating n number of OTIDs (one-time identifications) which are used in a user authentication; the client terminal sequentially selecting one of the generated n number of OTIDs in each authentication session with an authentication server on a network and to use the selected OTID as a user identification; receiving the n number of OTIDs from the client terminal an authentication server to store same; the authentication server receiving an authentication requisition from the client terminal; receiving the OTID selected from the n number of OTID and a secret key in response to the authentication requisition from the client terminal; and performing the authentication by inquiring the OTID from the DB (data base) and determining whether a secret key, which is associated with the inquired OTID and stored in the DB is matched to the received secret key.

In accordance with the present invention, by updating the user identification at each log-in or periodically and deleting the once used user identification, it is possible to prevent the user identification from being illegally used even though the user identification is leaked. Thus, damages and social expenses due to hacking of the user information may be much lowered.

Further, as identity and similarity do not exist between the identifications, similarity between the user identifications of a private person may be eliminated and an anonymous characteristic may be provided. Accordingly, user's identity and the private information may not be easily traced through a socio-technical method.

Furthermore, on a long-range view, as the validity time of the personal information is shortened, advantages from hacking personal information may be eliminated and the motives of hacking attempts may be reduced. Further, although the identification and the secret key are revealed, attackers or hackers may not succeed in log-in because they may not obtain a new one-time identification in each session. Therefore, leakage of user information, which is caused by the hacking of major sites such as portal sites and the like may be efficiently prevented, the hacking of major sites being a social problem.

### BRIEF DESCRIPTION OF THE DRAWINGS

The objects and features of the present invention will become apparent from the following description of embodiments given in conjunction with the accompanying drawings, in which:

FIG. 1 is a block diagram showing the configuration of a system for user authentication using a one-time identification in accordance with an embodiment of the present invention; and

FIG. 2 is a flow chart showing a control procedure of the user authentication using the one-time identification in accordance with the embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, maybe stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram. Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences maybe substantially executed simultaneously or often in reverse order according to corresponding functions.

Hereinafter, embodiments of the present invention will be described in detail with reference to the accompanying drawings which form a part hereof.

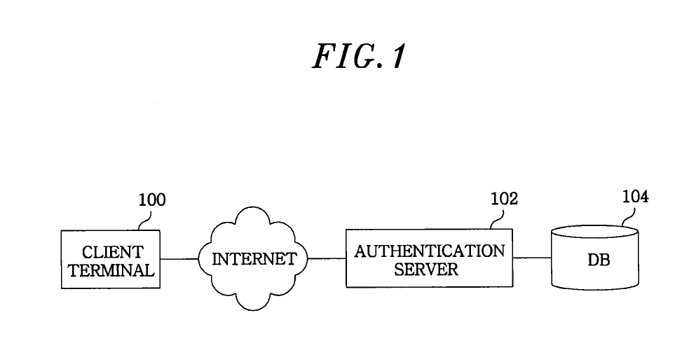

FIG. 1 is a block diagram showing a block diagram of a a system for user authentification using a one-time identification in accordance with an embodiment of the present invention.

Referring to FIG. 1, the operation of each component in the system for user authentification in accordance with the present invention will be described in detail.

The system for the user authentification using the one-time identification may include a client terminal 100, an authentication server 102 and a database (DB).

First, the method for the user authentification in accordance with an embodiment of the present invention may be classified into an initial registration process and a log-in process. In general, the initial registration process corresponds to a user registration process such as a procedure of joining web membership.

The initial registration process requires general user information and authentication information used in a user authentication process. The authentication information may include a user identification, an one time random number (OTR), and a secret key.

The user identification is input information used for making a one-time identification, and is used only in the initial registration process. The client terminal 100 uses resultant values which are obtained by inputting the user identification and the one-time random number to a hash function to repeatedly calculate n times under the consideration of using period of the one-time identification, as an one-time identification. Here, the client terminal 100 registers the n-th resultant value to an authentication server 102 as an initial one-time identification. Further, when a user logsin, the client terminal 100 sequentially uses the resultant values in descending order of (n−1)th, (n−2)th, . . . as the one-time identification.

The initial registration process in the authentication server 102 is similar to the general process of joining of web membership in a website. The authentication server 102 separates the user information and the authentication information transmitted from the user to internally manage same. Further, the authentication server 102 stores the one-time identification, i.e., the n-th resultant value and the secret key, which are included in the transmitted authentication information, into a DB (data base) 104. If the user transmits the one-time identification and the secret key to the authentication server 102, when the user logs-in, the authentication process is performed such that the authentication server 102 compares the resultant value obtained by inputting the transmitted one-time identification to the hash function with the initial one-time identification generated in the initial registration process to identify the user and the secret key.

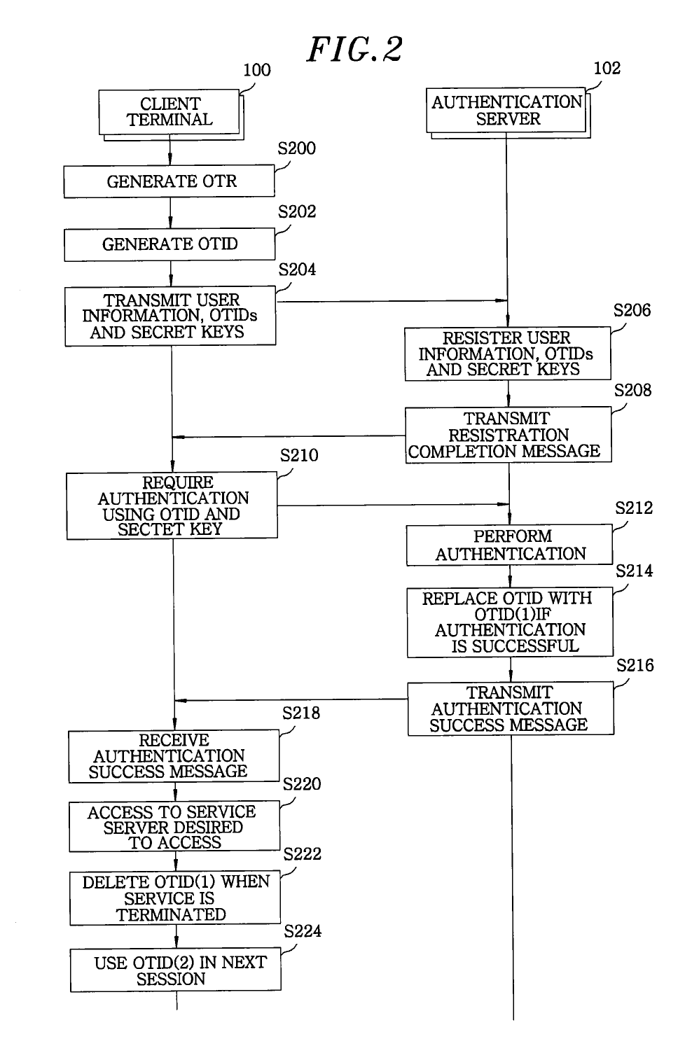

FIG. 2 is a flow chart showing a control process of user authentication using the non-fixed user identification in accordance with an embodiment of the present invention. First, the client terminal 100 generates the OTR, i.e., one time random number using a random number generator (not shown) in step S200. Next, in step S202, the client terminal 100 generates n number of OTIDs (one-time identifications) by inputting the user identification and the OTR as the inputs of the hash function to repeatedly calculate n times under the consideration of the using period of the one-time identification. The n OTIDs may include OTID=Hn, OTID(1)=H(n−1) and on the like.

Subsequently, in step S204, the client terminal 100 transmits the user information, the n number of OTIDs and secret keys to the authentication server 102 in the initial registration process.

Then, the authentication server 102 stores the user identification, OTIDs and secret keys transmitted from the client terminal 100 in the DB 104, registers the user using the OTIDs and the secret keys in step S206, and transmits a registration completion message to the client terminal 100 in step S208. In this case, the authentication server 102 separately stores information about the OTIDs and the secret keys and the user information in the DB 204.

As described above, the registration completion message is received from the authentication server 102, the client terminal 100 inquires an OTID(1) by indexing an address of a service server. In other words, the client terminal 100 uses the resultant value obtained by inputting the user identification and the OTR to the hash function to repeatedly calculate n times under the consideration of the using period of the one-time identification(OTID), as the one-time identification. Further, the client terminal 100 registers the OTID in the authentication server 102. When the user logs-in, the client terminal 100 sequentially uses the resultant values in descending order of (n−1) th OTID, (n−2) th OTID . . . as the OTID, as described above. The (n−1)th OTID and the (n−2)th OTID may be referred to as OTID(1) and OTID(2), respectively.

Accordingly, in step S210, the client terminal 100 inquires the OTID(1) to require an authentication by transmitting the inquired OTID(1) and the secret key to the authentication server 102.

In step S212, the authentication server 102 receives an authentication requisition from the client terminal 100 and calculates the OTID using the OTID(1) which is the OTID transmitted from the client terminal 100 as an input of the hash function, i.e., from an equation OTID=H(OTID(1)). Further, the authentication server 102 inquires the same OTID stored in the DB 104 using the calculated OTID and determines whether the secret key corresponding to the inquired OTID is the same as the secret key received from the client terminal 100. Through the above-mentioned processes, the authentication server 102 performs the authentication.

If the secret key received from the client terminal 100 is the same as the stored secret key which is associated with the inquired OTID, the authentication server 102 determines that the authentication is successful. Then, the authentication server 102 replaces the OTID stored in the DB 104 with the OTID(1) in step S214. Subsequently, the authentication server 102 transmits an authentication success message to the client terminal 100 in step S216.

When the authentication success message is transmitted from the authentication server 102, the client terminal 100 receives the authentication success message in step S218, accesses to a service server desired to access in step S220. Further, the client terminal 100 deletes the OTID(1) when a service session is terminated in step S222 and uses the OTID(2) in a next session in step S224. In other words, the client terminal 100 performs a log-in process in each session using the OTID through the OTID(n−1).

Meanwhile, in a method for synchronizing the client terminal with the authentication server, the client terminal and the authentication server need to check each other whether a session therebetween is terminated when the session therebetween is unstably terminated. Such a check needs to be performed before the OTID is updated between the client terminal and the authentication server. In another method for synchronizing the client terminal with the authentication server, the authentication server may update the OTID stored in the DB received from the client terminal after the authentication is successful, when another OTID which is obtained by repeatedly applying the received OTID to the hash function within a specific range, is matched to the received OTID. The synchronization between the client terminal and the authentication server may be performed using the above two methods.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A system for user authentication using OTIDs (one-time identifications), the system comprising:
a client terminal configured to generate n number of OTIDs which is used in the user authentication, and sequentially select one of the generated n number of OTIDs to use the selected OTID as a user identification in each authentification session; and
an authentication server configured to receive the generated n number of OTIDs from the client terminal to store same, when the one OTID selected from the n number of OTID and a secret key are transmitted, inquire the OTID in a DB (data base), and determine whether a secret key which is associated with the inquired OTID and stored in the DB and the received secret key is matched to performing the user authentication.

2. The system of claim 1, wherein the client terminal deletes the OTID used once to prevent same from being used in a next session of the user authentification.

3. The system of claim 1, wherein the client terminal generates n number of OTIDs by inputting the user identification and an OTR (one-time random number) to a hash function.

4. The system of claim 1, wherein the client terminal performs a registration process by transmitting the OTIDs, the secret keys and user information to the authentication server on a network, require the user authentication by transmitting a (n−1)th OTID(1) and the secret key, deletes the OTID(1) to use (n−2)th OTID(2) as the user identification in a next session when the user authentication is successful.

5. The system of claim 1, wherein the authentication server performs a user registration process using the n number of the OTIDs which are used as the OTID, the n number of secret keys and user information received from the client terminal; when the (n−1)th OTID(1) and secret key are received in response to an authentication requisition of the client terminal, performs the user authentication by calculating the OTID using the OTID(1), inquiring the calculated OTID in the DB, and determining whether the secret key which is associated with the inquired OTID and the secret key received from the client terminal is matched.

6. A method for user authentication using a one-time identification, comprising:
a client terminal generating n number of OTIDs (one-time identifications) which are used in a user authentication;
the client terminal sequentially selecting one of the generated n number of OTIDs in each authentication session with an authentication server on a network and to use the selected OTID as a user identification;
receiving the n number of OTIDs from the client terminal an authentication server to store same;
the authentication server receiving an authentication requisition from the client terminal;
receiving the OTID selected from the n number of OTID and a secret key in response to the authentication requisition from the client terminal; and
performing the authentication by inquiring the OTID from the DB(data base) and determining whether a secret key, which is associated with the inquired OTID and stored in the DB is matched to the received secret key.

7. The method of claim 6, wherein said using the selected OTID as a user identification is performed such that the user identification once used is deleted to prevent same being used in a next session of the user authentication.

8. The method of claim 6, wherein said generating n number of OTIDs includes generating the n number of OTIDs by inputting the user identification and an OTR (one-time random number to a hash function.

9. The method of claim 6, wherein said using the selected OTID as a user identification includes:
performing a registration process by transmitting the OTIDs, the secret keys and user information to the authentication server on a network;
requesting the user authentication by transmitting a (n−1)th OTID(1) and a secret key after the registration is successful; and
deleting the OTID(1), when the authentication is successful, and requesting the user authentication using a (n−2)th OTID(2) as the user identification in the next session.

10. The method of claim 6, wherein said performing the authentication includes:
receiving the n number of OTIDs which are used as the OTID, secret keys, and user information from the client terminal to use store same;
receiving the (n−1)th OTID(1) and the secret key in response to the authentication requisition of the client terminal;
calculating the OTID using the OTID(1), and inquiring the calculated OTID from the DB; and
performing the user authentification by determining whether the secret key which is associated with the inquired OTID is matched to the secret key received from the client terminal.
